(19) United States
(12) Patent Application Publication
(10) Pub. No.: US 2012/0177436 A1
(43) Pub. Date: Jul. 12, 2012

(54) Tubular slide lock mechanism

(76) Inventor: Denis E. LaBombard, Georgetown, MA (US)

(21) Appl. No.: 13/374,717

(22) Filed: Jan. 9, 2012

Related U.S. Application Data
(60) Provisional application No. 61/431,039, filed on Jan. 9, 2011.

(51) Int. Cl. F16B 7/14

(52) U.S. Cl. 403/109.1

(57) ABSTRACT

A mechanism and system for reversibly locking together concentric tubular components uses a projection on the outer tube for interacting with a component having a taper. When the larger outer tubing is forced along the inner tubing towards a limiting opening, a tapering section of the tube assembly is forced against the projection, thereby reversibly forcing the paired tubes into a locked position. The tubing can be unlocked by exerting pressure with one hand to separate the projection from the tapered section, thereby unlocking the tubing. Optionally, a second hub segment rides on the outer tube, and latches with a simple manual snap fit to the first hub segment. The mechanism and system is useful for locking and unlocking concentric tubing within a medical instrument, while leaving one hand free for other parts of a procedure.

This application claims the benefit of the priority of co-pending provisional application 61/431,039, which is incorporated herein in its entirety by reference.

### FIELD OF THE INVENTION

The present invention relates generally to an apparatus and method for controlling and locking the rotational and axial position of an inner cylindrical component, such as tubing or wire, residing within an outer tubular sheath component, thereby serving as a delivery system or hollow bore catheter. The relative position of the outer and inner components can be locked or unlocked by an operator using only one hand. The device is useful in medicine, surgery and related areas.

### BACKGROUND OF THE INVENTION

This invention relates to an improved mechanism for reversibly locking the relative position of cylindrical objects—tubing or wire—inside a surrounding tube. Such a situation is found in medicine, for example, where an outer tubing segment is used to control and localize a flexible inner tubing or wire that is used to place a medical device within the body or manipulate such a device. An example of such a system is the placement of a snare within the body, for example to remove a gallstone. The snare runs within a length of flexible tubing, which in turn passes through tubing with a larger diameter held outside the patient. In the course of ensnaring and withdrawing a gallstone, there are times when the length of inner tubing within the body needs to be changed, with respect to the handpiece, and other times when it needs to be held at constant length.

A current device for adjusting the snare position uses a screw-cap mechanism to lock the inner and outer tube together. The cap is unscrewed to allow repositioning, and then tightened to exert compressive force of the screw cap against the tubing to retain the new position. Accomplishing this maneuver requires two hands and a significant force. The devices are known in the medical field as “torquers”, and are represented the art in U.S. Pat. No. 5,161,534, Berthiaume.

More generally, there are many techniques employed to lock the relationship of concentric tubular or cylindrical embodiments in position. The use of collets and/or slit tubes in the art to hold tools, drills and surgical instruments in a locked position, in relation to a handle, a drill, a chuck, and/or a tubular handle construct (either rotating or stationary), is well known. Examples include U.S. Pat. No. 668,286 Freese, U.S. Pat. No. 2,056,693 Fuchs et al., U.S. Pat. No. 2,138,012 Perr, U.S. Pat. No. 2,438,797 Bagge, U.S. Pat. No. 2,618,496 Johnson U.S. Pat. No. 3,144,178 Sarnoff, U.S. Pat. No. 3,411,796 Decker, U.S. Pat. No. 3,549,159 Kroener, U.S. Pat. No. 4,681,056 Friedle et. al. U.S. Pat. No. 6,254,589 Raoz and U.S. Pat. No. 7,812,606 Burns. These patents show the evolution in the art of a collet-like system, wherein a tubular member with conical surfaces and multiple finger-like projections is diametrically compressed onto a center core member by the sliding motion of an outer or inner sleeve axially progressing along the conical finger-like portion. The sliding motion typically is generated by threads or a similar means to enable the user to generate enough force to provide locking of the members together. U.S. Pat. No. 5,921,561 Cedarberg III describes similar constructs in collet and slit tube design, and also provides a means for a slideable locking motion along the axis of the assembly to achieve the required locking condition.

Most of this art provides precision and concentricity of the engaging features along with an axial symmetry design of the individual members such as fingers, conic sections or the like, and is designed to ensure that the concentricity and axial alignment of the item being held is related to a rotational centerline axis defined by the embodiment. The general term for such a device is a “collet”. Such stringent requirements for concentricity require precision manufacturing techniques, and may require that the components be structurally robust, e.g. metallic. These design features are essential in some applications where there is a need for axial alignment and minimal run-out of the assembly. Examples include precision CNC equipment and high speed rotational use.

However, there is a distinct disadvantage in the cost including assembly time of such embodiments, when used for controlling medical devices, in particular those comprised of small diameter sliding tubular members. This is especially true where the L/D ratio [Length to Diameter] of the medical device is greater than about 10 to 1.

Another difficulty with current systems, especially those using collets, such as “torquer” systems, is their requirement for two-handed use. The proper manipulation of a catheter in a medical procedure using a collet or torquer requires both hands hands to hold the axial position while it is being locked. Surgical procedure devices in this class, including devices such as catheters and snares, are typically used in endoscopic procedures either alone or through the endoscopic instruments themselves. These devices need to be both very cost effective and disposable. In some instances where collets and similar devices are used, the component count and cost of the controlling portion of the device is greater than the rest of the instrument assembly.

There is a need for a medical device with an inexpensive locking system for tubing. Many devices in this category would have enhanced functionality if they were equipped with a simple locking design for position and control. Preferably, such a system is designed to minimize parts and cost. There is a further need for an inexpensive locking system that can be activated with one hand where the number of components and the cost is at a minimum. In the case of the elongated 10:1 L/D ratio class of devices previously described (for example, catheters), the axial alignment does not require high precision. Precision alignment features are not required for large L/D device control because the proximal, controlling end of the device, where the improvement of the present invention is located, is a relatively large distance from the operating or functional distal end. Hence, the relative precision and high cost of a collet are not needed, and a simpler, cost-effective integrated design such as the present invention is preferred because it is simpler to operate, it is cheaper, and it meets the need of the clinician for one hand operation.

One handed operated torquers for securing ultra small diameter guide wires are represented in the art by U.S. Pat. No. 7,144,378, Arnott and U.S. Pat. No. 5,325,868 Kimmelstiel. While adequate for holding and controlling a single wire, they are not constructed or designed to effectively control and manage the position of tubular members when they are axially sliding and rotating.

The preferred embodiment of the invention, in using an axial motion for control, provides an improved and more intuitive device to the user for locking the apparatus as compared to this prior art. The motion of locking can be by design directly aligned with the natural controlling motion used in managing the apparatus residing at the distal end of the apparatus.

The interaction of tapered elements of a mechanism has been found to solve some of these problems, as described below. A detailed description of taper elements may be found in luer lock taper standards as defined in publication ISO 594-2:1998, “Conical Fittings with a 6% (Luer) Taper for Syringes, Needles, and Certain other Medical Equipment”).

### SUMMARY OF THE INVENTION

It is an object of this invention to demonstrate a simple, inexpensive, proximally placed control mechanism, useful for high L/D (length/diameter) elongated medical devices, that will allow for full rotation, axial translation and fixation without the need for precision collet-like or torquer constructs known in the current art.

It is an object of this invention to demonstrate a simple inexpensive proximally placed control mechanism for use with catheter-like medical devices that will fixate the members using an axial sliding motion.

It is a further object of this invention to demonstrate that a simple, inexpensive, proximally placed control mechanism providing full rotation, axial translation and fixation can have its fixation feature activated using one hand.

The invention describes a proximally placed control mechanism for fixing and locking the position of an outer tubular first member in relation to an inner tubular or cylindrical solid second member, said second member residing within the central volume of said first outer tubular member, by using a simple third member, said third member enclosing the first and second members, and using an axial sliding motion of said third member with respect to said first and second members to lock the first member to the second member, in order to reversibly control the relative positions, fixation, and rotational relationship of these members.

The invention further comprises an optional and preferred fourth member, sliding on the second, larger tube, which has a reversible connection with said third member. Said fourth member is designed and constructed so that said first and second members can be released to slide with respect to each other by the separation of said third and fourth members.

The invention further demonstrates a low cost, easy to manufacture assembly which comprises at least:

a first outer tubular member;

a second inner member which is one of a wire, a cylindrical core, and a tubular construct, which inner member is positioned concentrically within said first member in a manner which is moveable both rotationally and longitudinally;

and a third sliding outer member encompassing said first and second members which are sliding and rotating within said third member.

The invention in one preferred embodiment further defines and establishes the relationship and selection of materials for each of the first, second and third members within the assembled mechanism such that the Young's modulus [‘E’] of one of the members is in the general range of about 1/10^{th} or less of the modulus [‘E’] of one of the two other remaining members.

The invention further describes the third sliding outer member as slideably displaced along the axis of the mechanism and the first two members such that when engaged with the first and second members the encompassed geometry engaged therein among the first second and third members binds the first, second and third members together immovably. When the third sliding outer member is slideably reversely displaced along the axis of the mechanism the first and second members are completely free to rotate in relation to each other and the third member as well as translate axially in relation to each other and the third member.

The invention further describes a fourth hub member. The purpose of the fourth hub member in the mechanism is to provide a means to limit the total axial displacement sliding motion of the third sliding outer member, and to assist the user by comprising a finger-size geometry which allows the user to easily operate the mechanism with only one hand.

### BRIEF DESCRIPTION OF THE FIGURES

FIG. 1 illustrates the tubular slide lock assembly in an isometric view.

FIG. 2 illustrates the components of the tubular slide lock assembly in an exploded view.

FIG. 3 illustrates locking interacting geometry of the first outer tube member.

FIG. 4 is a front view of the most distal end of the first tubular member and illustrates key attributes in the locking section of said first outer tube member.

FIG. 5 is a cut away of the first and second members as assembled illustrating the functional locking geometry and critical geometric relationships.

FIG. 6 is a 90 degree rotated view of FIG. 5 with a focus on the locking section.

FIG. 7 illustrates the details of the third outer sliding member as a cross section view.

FIG. 8 illustrates the details of the fourth outer hub member as a cross section view.

FIGS. 9 and 10 illustrate a cross sectional view operation of the assembly in the unlocked and locked state.

FIGS. 11 and 12 illustrate an alternate geometric functional relationship of components in a cross sectional view and an exploded view.

### DESCRIPTION OF THE INVENTION

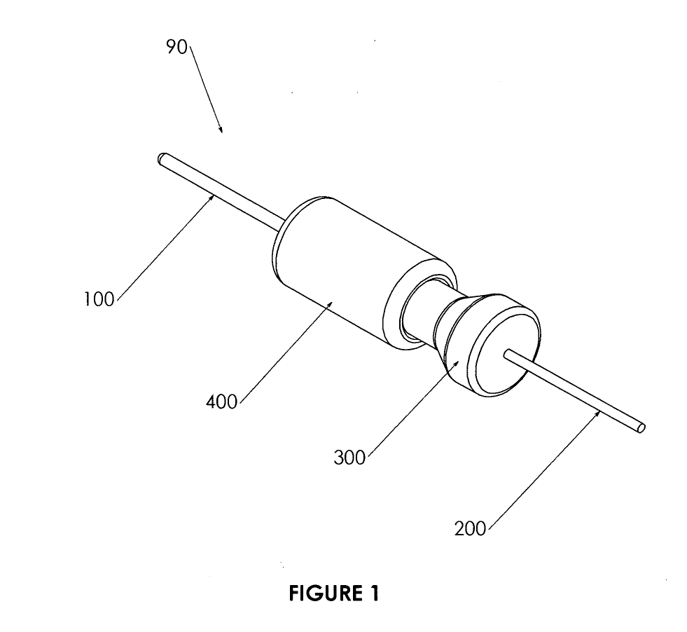

FIG. 1 shows the present invention, which comprises a low cost, easy to manufacture tubular slide lock assembly [90] which is comprised of:

a first outer member [100] comprising a tube, said tube having a projection which is not fully cylindrical; a second inner member [200] comprising a cylinder (for example, a wire) or a tubular construct, positioned in a slideable and rotatable manner within said first tubular member [100]; and a third sliding outer hub member [300], encompassing said first [100] and second [200] members, and permitting said first and second members to slide and rotate within outer sliding hub member [300]; and optionally further comprising a fourth hub member [400], which can engage hub member [300] so as to limit the axial sliding distance of said hub member [300] along first tubular member [100].

Fourth hub member [400] is positioned on hub member [300] such that when hub member [300] is slid most proximally in relation to member [400], member [200] is free to rotate and translate without restriction. Conversely when hub member [300] is slid distally, members [100], [200] and [300] are mutually locked together.

The invention further defines and establish the relationship and selection of materials for each first, second, third and fourth member within the assembly mechanism such that the modulus of elasticity [‘E’] (Young's Modulus) of one or more of the members, preferably one or two, is in the general range of 1/10^{th} of the modulus [‘E’] of the other members.

The invention further describes a third sliding outer hub member [300] which may be slideably displaced along the axis of the mechanism and the first two members such that when engaged with the first [100] and second [200] members, a projecting section of said first member interacts with said second and third members so as to lock the first, second and third members together immovably. Moreover, when the third sliding outer hub member [300] is reversely displaced along the axis of the mechanism, the first and second members are unlocked and completely free to rotate in relation to each other and to the third member as well as to translate axially in relation to each other and the third member.

The invention further describes a fourth hub member [400]. The purpose of the fourth member in the mechanism is to provide a means to limit the total axial displacement sliding motion of the third sliding outer member [300], and also to allow the user to easily operate the mechanism with only one hand.

FIG. 1 shows a perspective view of the preferred embodiment of the tubular slide lock assembly [90] illustrating a typical tubular assembly structure using 1.5 mm tubing, comprising: a first outer tubular member, [100]; a second inner member [200] which is a cylindrical core, a wire or a tube, located concentrically, slideably and rotationally within said first tubular member [100]; a third sliding outer hub member [300] encompassing said first [100] and second [200] members which are sliding and rotating within said third sliding outer member [300]; and a fourth hub member [400] axially aligned and immovably linked to first tubular member [100], and positioned to provide a means to limit to the total axial displacement sliding motion of the a third sliding outer member [300], and to assist the user to easily operate the mechanism with only one hand.

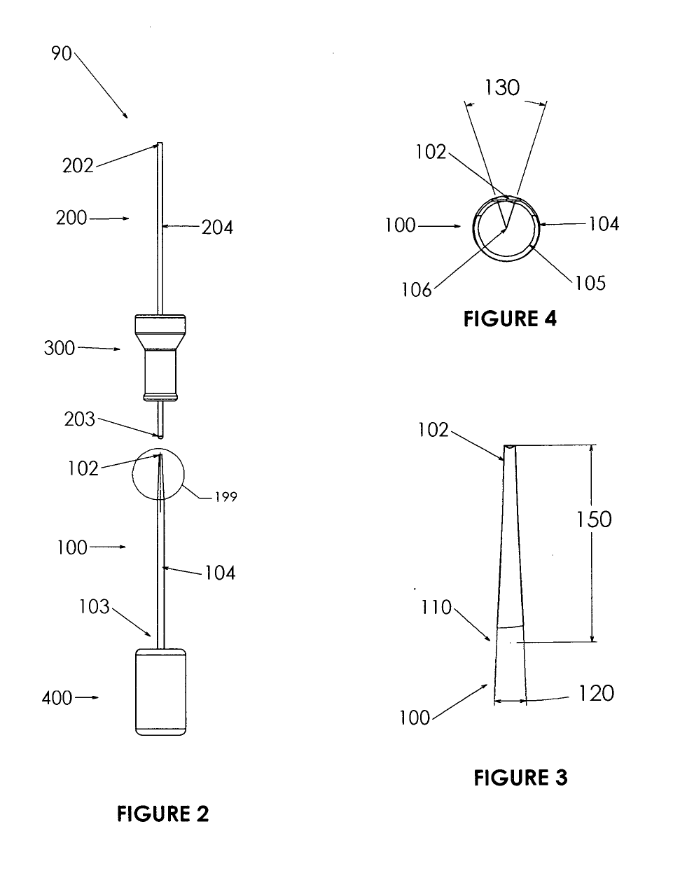

FIG. 2 illustrates an exploded view of the tubular slide lock assembly [90]. First outer tubular member [100] is comprised of a distal end [102], a proximal end [103], an outer surface [104], and an inner surface [105] defining a clear central volume [106] (see FIG. 4). First member 100 is typically constructed of hypodermic-type (“hypo”) tubes or other thin wall tubular extrusions used in medical instruments. The wall thickness of such tubes is typically in the range of 0.002 to 0.030 inches. The wall thickness of a preferred embodiment of the present invention is approximately 0.005 inches (ca. 0.125 mm). Such a ‘hypo tube’ or “precision miniature stainless steel welded and drawn tubing” (see, e.g., “McMaster-Carr 2010 Catalogue” Pg 128-129 Gage Size 3 to 33) is well known in the medical device art, and is preferably constructed from the class of corrosion resistant steels with a Young's modulus [‘E’] in the range of approximately 29 million. (For the purposes of clarity, in the Figures the first outer tubular member [100] may be a 16X Hypotube™ (0.065×0.057), and second inner tubular member [200] may be an 18S Hypotube™ (0.050×0.038), shown in the figures as a solid rod.)

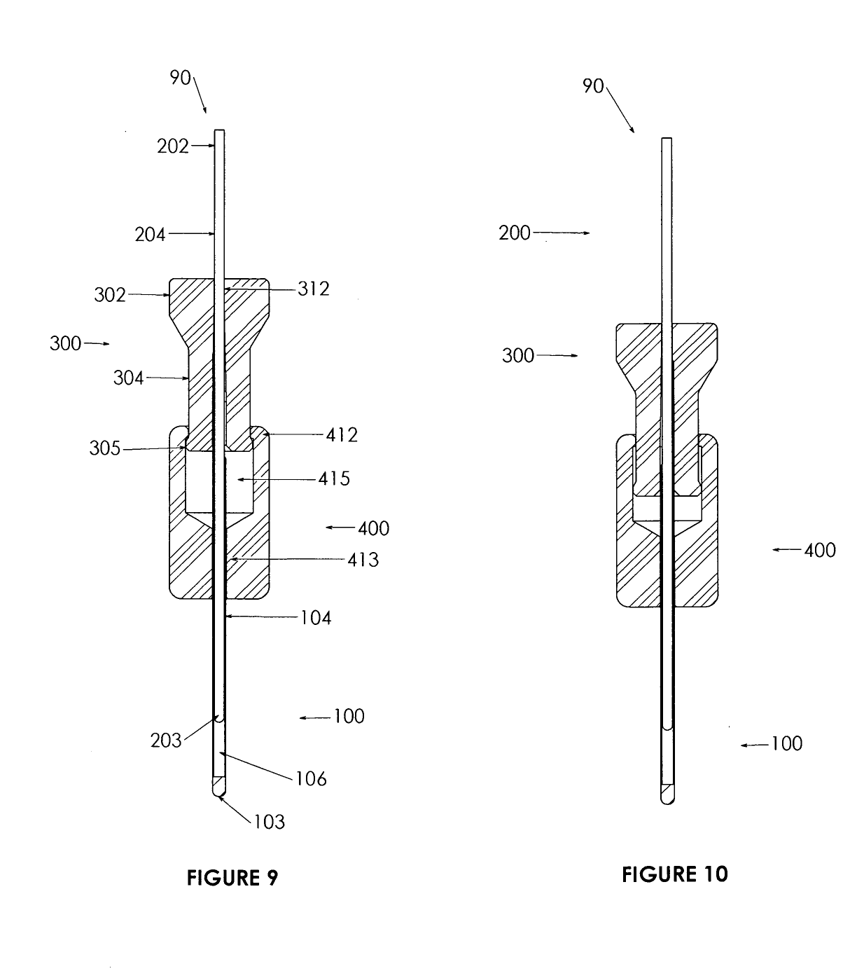

Referring to FIGS. 2, 3, 4 and 5, the first outer tubular member [100] in the preferred embodiment has its most distal end [102] modified to provide a tapered projection along its length from intermediate proximal position [110] to most distal end [102], such that the included angle [120] of the distal projection portion, as shown in FIG. 3, is approximately 6 degrees; and where in the view perpendicular to the axis, as viewed distal to proximal in FIG. 4, the most distal end [102] of the tapered projection of first outer tubular member [100] occupies an angular section segment [130] in the range of 10 to 45 degrees. Proximal end [103] of first outer tubular member [100] may be closed or open. For purposes of illustration and clarity proximal end [103], best seen in FIGS. 9 and 10, is depicted as closed.

A “tapered” or “tapering” projection, element, part, or the like, as referenced in this description, can best be geometrically described as a generally elliptical projected cross-section shape as viewed perpendicular to the face of the described cut of the cylindrical or tubular geometry.

Referring to FIG. 2 and FIG. 4, second inner tubular member [200] is comprised of a solid cylindrical core (e.g. a wire), or a tubular embodiment similar to the first member, and has distal end [202], proximal end [203], and outer diameter [204]. The outer diameter [204] of second inner member [200] along its complete length is sized such that second inner member [200] is located generally concentrically within first tubular member [100], and can freely slide and rotate within the clear central volume [106] of said first tubular member [100], without binding on the inner diameter [105].

In a preferred embodiment of the present invention, second inner member [200] is preferably constructed from the class of corrosion resistant steels with a modulus [‘E’] generally in the 29 million range. For the purposes of illustration and clarity second inner member [200] is shown as a solid cylindrical rod or wire.

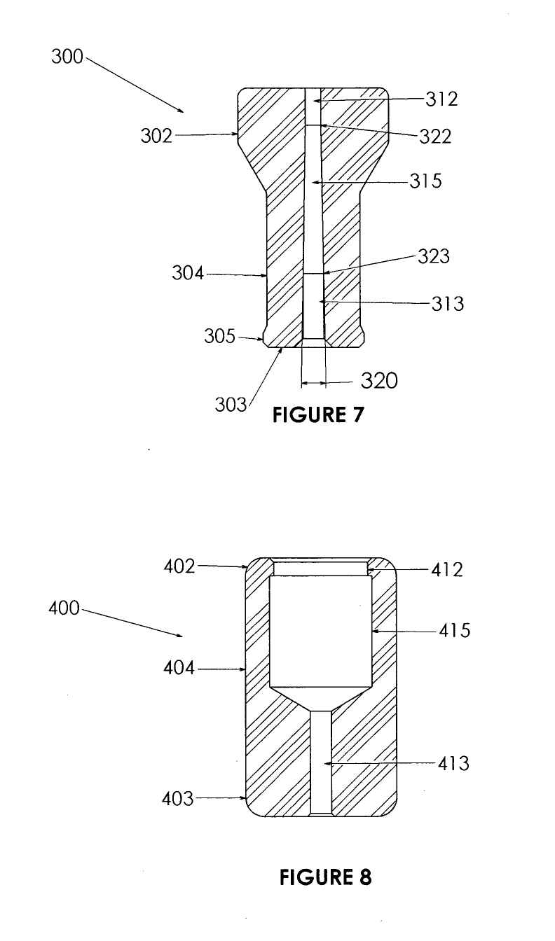

Referring to the exploded view (FIG. 2) and cross-section view (FIG. 7), third sliding outer hub member [300] is comprised of a cylindrical hub distal end [302], tapering smaller in diameter to a mid section outer body [304] and terminating at a proximal snap fit outer diametrical feature [305], which is somewhat larger in diameter than mid section outer body [304].

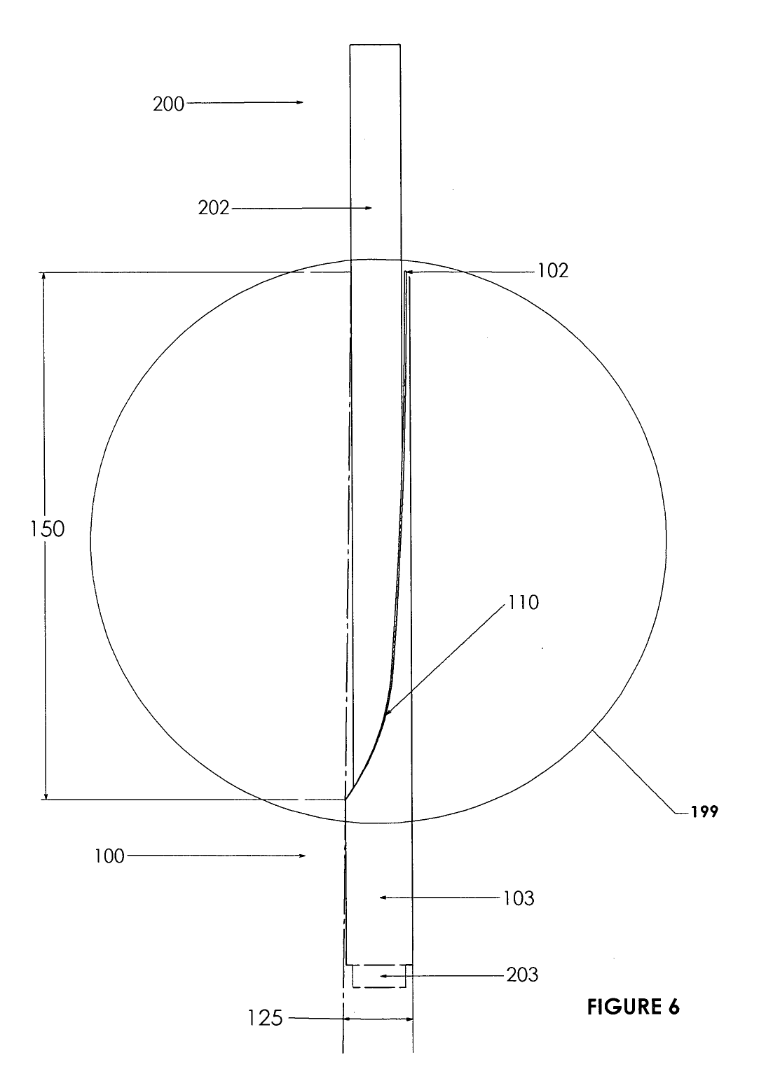

A series of concentric bore segments are present along the center line axis of third member [300]. At the distal end, a first distal inner bore segment [312] is sized to be generally about 0.001 to 0.003 inches larger than the diameter [204] of second member [200] (see FIG. 1, FIG. 9). Likewise, at proximal end [303], the inner diameter of segment [313] is sized generally to be about 0.001 to 0.003 inches larger than the outer diameter [104] of first tubular member [100] (FIG. 1, FIG. 9). A conical taper bore [315], similar to a female luer-type connection, concentrically connects the distal segment [312] with the proximal segment [313]. The length of tapered section [315] is at least about half the length of the entire bore length (FIG. 7), and at least as long as the distance in FIG. 6 within circle [199] from the distal end [102] to the intermediate proximal position [110] of first tubular member [100]. Also, the nominal lengths of the inner diameters of sections [312] and [313], taken together, are each generally ½ the length of bore [315]. At the end 303, there is a widening of the bore at the surface to improve entry of a tube. In a preferred option, segment 313 has a large chamfer to facilitate entry of large tube [104] into third member [300].

In a preferred embodiment of the present invention, third sliding outer hub member [300] is preferably comprised of materials with a modulus [‘E’] generally 1/10^{th} or less of the Young's modulus [‘E’] of the first and/or second members. Such a relationship could be an [‘E’] modulus of 29 million for the first and second members (classes of steels and hard rigid metals) and a modulus of 2.9 million or less for the third sliding outer member [300], which may be made of a plastic material such as an engineering injection molded or machined thermoplastic, or a thermoset material such as, but not limited to, commercial resins such as Torlon, Delrin, Polycarbonate, PVC or ABS. A similar modulus and similar materials are suitable for the fourth hub member. It is preferred that one or both of said third and fourth members have a low modulus.

In a second preferred embodiment of the present invention, third sliding outer hub member [300] is comprised of materials with a modulus [‘E’] generally 70% or more of the modulus [‘E’] of the first and/or second members. In another preferred embodiment of the present invention, such a defined modulus could be an [‘E’] modulus of 29 million for the first, second and third members (classes of steels and hard rigid metals). In either of these cases, a fourth member would still preferably be made of a material with a lower modulus, for example about 1/10^{th} of the value of the modulus of the other material, in order to facilitate the snapping of the fourth member onto the third member during assembly.

Referring to exploded view FIG. 2 and cross-section view FIG. 8, fourth hub member [400] is comprised of a cylindrical body whose outer diameter [404] is approximately the same as the diameter of distal end [302] of third sliding outer member [300].

Fourth hub member [400] has distal end [402] and proximal end [403] connected by an axial bore. Axial bore concentric axial features, proximal to distal, include a snap fit inner ring [412], which is diametrically sufficiently less than the outer diameter of snap fit feature [305] of third member [300], so that once assembled, feature [412] will snap onto and retain feature [305] within inner cavity [415] of hub [400]. Inner cavity [415] is typically sized at least 0.005 to 0.010 inches larger than snap fit feature [305] of third sliding outer member [300], so third sliding outer hub member [300] can axially slide in relation to fourth hub member [400].

Completing the axial bore through central bore pathway of the fourth hub member [400] is a bonding surface [413] which is sized for a slip fit onto outer diameter [104] of first outer tubular member [100] such that first outer tubular member [100] and fourth hub member [400] may be immovably fixed to each other, in a manner that permits reversal of the immobilization.

In a preferred embodiment of the present invention, fourth hub member [400] is most preferably but not exclusively comprised of materials with a modulus [‘E’] generally about 1/10^{th} or less of the modulus [‘E’] of the first and/or second members and has properties most compatible for a snap fit with hub member [300] and bonding to said first outer tubular member [100]. A typical modulus of 2.9 million or less for the fourth hub member [400] is most preferred for ease of manufacture and assembly.

Member [400] may be made of a plastic material such as an engineering injection molded or machined thermoplastic, or a thermoset material such as, but not limited to, commercial resins such as Torlon, Delrin, Polycarbonate, PVC or ABS.

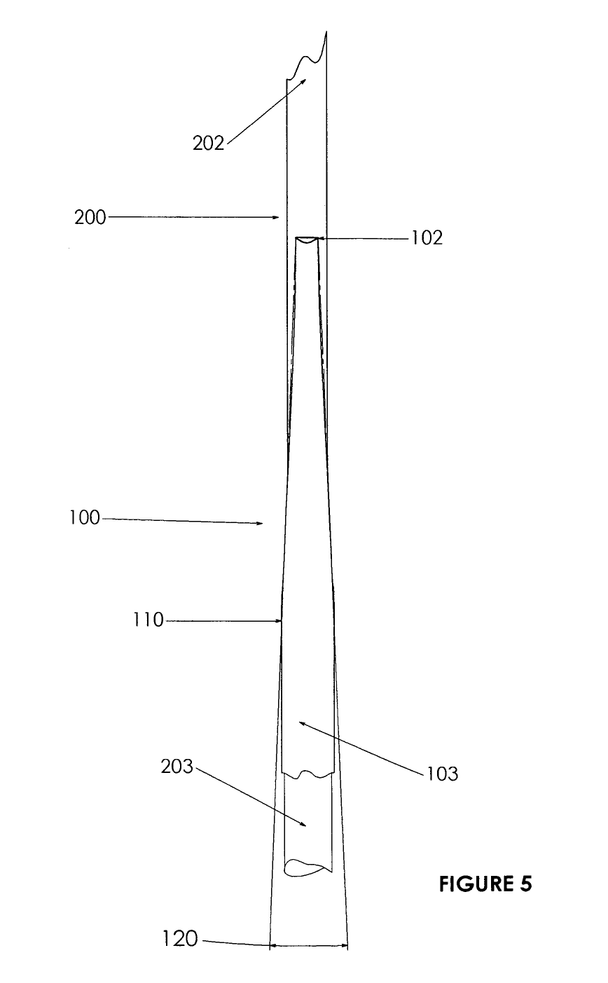

Referring to FIG. 5 and FIG. 6, a cutaway is shown of an assembly of first outer tubular member [100] to the second inner member [200], and defines the interacting locking geometry of first outer tubular member [100] and second inner member [200] which interfaces with a tapered section [315] of third sliding outer member [300].

FIG. 5 shows the detail of the most distal end [102] of first outer tubular member [100], with second inner member [200] residing in the clear central volume [106] (see FIG. 4) of said first outer tubular member [100]. Second inner member [200] is capable of axial and rotational motion, and may pass completely through first outer tubular member [100] such that distal ends [103] and [203] respectively (not shown) are generally in close proximity, as seen for example in FIGS. 9 and 10).

In the invention, the first outer tubular member [100] is cut to form a tapering projecting section [150], most preferably of single cut geometric profile, the tapering projection running from the most distal end [102] of tube [100] to the intermediate proximal position [110]. The tapered projecting member is shown in FIG. 5. In the preferred embodiment for a 1.5 mm assembly, the projected angle [120], as shown in FIG. 5 and FIG. 3, is in the range of about 10 degrees or less.

This removal of material from the distal end [102] of first outer tubular member [100] to create the “profile length” [150] (FIG. 6) is accomplished in manufacturing by generating the complex geometry profile cut shown in FIG. 6 (which is a 90 degree rotation view of FIG. 5). This profile cut begins on the outside of the tube [100] at mid proximal position [110] and ends at distal end [102,] where the cut exits the tube distally a small distance away from the far edge of tube [100], leaving a small portion of the distal tip cross-section intact.

The length of the partially elliptical cutaway projection profile [150] of tubular member [100], shown in FIG. 5 (a 90 degree rotation of FIG. 6), is defined as an acute tapering angle section of said length projection [150] of about 6-10 degrees and has a width between said tapering angle sections which consists of the uncut distal tip portion of tube [100].

In FIG. 6, a 90 degree axial rotation of FIG. 5, this geometry generates a shallow angle virtual conical projected profile along projecting length [150], and in this view in combination with second inner member [200] has a taper angle [125]. Taper angle [125] is generated from the assembly of outer tubular member [100] and the cylindrical geometry of second inner member [200]. The taper [125] in the FIG. 6 orientation along projecting length [150] of the first outer tubular member [100] and second inner member [200] as an assembly is gradual, and is preferably less than 10 degrees, more preferably less than about 5 degrees. Said taper angle [125] (as seen in FIG. 6) may be defined as the tan⁻¹ of the measured width of the assembly of member [100] and member [200] at the most distal end [102] of member [100] minus the measured diameter at the intermediate proximal position [110] of member [100], divided by the axial distance of feature [150] on member [100] (i.e., the axial length from distal tip [102] to the intermediate proximal position [110]) of first outer tubular member [100]).

In a preferred embodiment of the invention for a 1.5 mm diameter tube [100], the tapering value (or full angle) [120] for the projecting section [150], as seen in FIG. 5, is in the range of 2 to 6 degrees, and the tapering angle [125] of said projecting section [150] (including second inner member [200] residing within the assembly as shown in FIG. 6) is in the range of 1-3 degrees.

Thus a virtual conical taper geometry has been created, as shown within circle [199] of FIG. 6, but without the need for a physical conical taper surface of revolution feature. The physical conical taper is required and defined in the collet art and ISO luer specifications for locking, but a virtual conical taper geometry, as defined by the assembly of [100] and [200], is asymmetric by design and is not believed to be described in the relevant art or literature.

Referring to FIG. 7, showing a cross section of third sliding outer member [300], the distal inner diameter [312] is sized generally 0.001 to 0.003 inches larger than the diameter [204] of second tubular member [200], in order to enable a freely sliding and rotating fit of outer tubing [200] through zone [312] of member [300]. The proximal inner diameter [313] is sized generally to 0.001 to 0.003 inches larger than the outer diameter [104] of first tubular member [100] to ensure a freely sliding fit for outer tubing 100 through zone [313].

There is a preferred range of angles defining the widening of the inner passage [315] in FIG. 7, from distal end [312] to proximal end [323] which is indicated at the bottom of the figure as full angle [320]. Angle [320] is preferably greater than full angle [120], so that passage [315] is wide enough at the most proximal end [323] to allow entry of distal end [102] into passage [315], and the closing of passage [315] is at a greater rate (per unit of lengthwise travel) so that the diameter of passage [315] becomes smaller than the width of projection [110] at some point within the passage [315].

In a preferred embodiment as described above, by selecting a hypo tube with a 0.005 nominal wall thickness for first outer tubular member [100], and by defining a length of a luer-like tapering zone [315] which is at least equal to the axial distance from distal feature [102] to the intermediate proximal position [110] of first outer tubular member [100], as shown within circle [199] in FIG. 6. If this is done, then the conical surface taper angle [320] (shown in FIG. 7) will be no less than 2 degrees.

As a result, as third sliding outer hub member [300] is moved further into fourth member 400, distal to proximal, along first outer tubular member [100], so that the angle defined by luer-like taper segment [315] of the inner wall of third sliding outer member [300], and second inner tubular member [200], will meet the leading end [102] of first tube [100] and be forced into the above-mentioned angle and further engaged along length [150], thereby reversibly locking the tubes [100] and [200] together with third outer hub member [300] and preventing any further relative motion of these three components until the locking is disengaged. If there is a fourth hub component [400] in the system, it will likewise be locked in position.

Unlocking is accomplished by applying force to separate the leading edge [102] and engaged length [150] from the intersection of tube [100] and the wall of bore [315]. This is most easily accomplished when the fourth hub 400 is present in the device, because when it is present, simple longitudinal finger or thumb pressure directed to separating hub member [300] and hub [400] can be sufficient.

Third sliding outer hub member [300] preferably is made of a material with a modulus [‘E’] that is 1/10^{th} or less of the modulus of the first and second members. Hence, third sliding outer hub member [300] is also more compliant at the interacting taper [315] geometry when there is a taper angle [320] such that there is radial compression and displacement of the geometry within circle [199], as shown in FIG. 6, that is sufficient to generate a 6-10 lb locking force or more of the first outer tubular member [100] in relation to the second inner member [200]. This is more than adequate for securing most catheter technology based medical devices against relative movement of the outer tube [100] with respect to the inner tube [200].

It is advantageous to have very shallow interacting angles of the locking and sliding geometries in the design similar to that best described by ISO 594-2:1998 “Conical Fittings with a 6% (Luer) Taper for Syringes, Needles, and Certain other Medical Equipment”. Such shallow angles require much less axial driving force to attain engagement and locking. These smaller axial forces are preferably in the range and capability of forces that can be generated by using one hand on a sliding assembly and are by design more than adequate to ensure a secure locking condition.

FIG. 9 and FIG. 10 illustrate the operation of the preferred embodiment of the present invention. Second inner tubular member [200] is slideably and rotationally located within the open central volume [106] of first outer tubular member [100]. Third sliding outer hub member [300] is able to slide freely axially, and is only constrained in total range of translation by the snap fit inner ring feature [412] of fourth hub member [400]. As described above, fourth hub member [400] is preferably immovably attached to first outer tubular member [100]. This prevents third sliding outer hub member [300] from an extreme translation towards the distal end of the device.

FIG. 9 illustrates positional relations where the first second and third members are free to rotate and to translate in relation to each other, and in this design the first and fourth members are attached to each other. In the device as shown in FIG. 9, the inner tubular member 200 can be moved forward or backward with respect to hub 400 without being retarded or halted by interaction with other components.

FIG. 10 illustrates positional relations where all members of the assembly are immovably locked together. The locking occurs when the third hub member [300] is pushed proximally from its position in FIG. 9 to a more deeply inserted position in fourth hub member [400] in FIG. 10. In this process, the projection, i.e. the tapering length [150] running from tip [102] to intermediate point [110], as best seen within circle 199 of FIGS. 2 and 6, protrudes upward in FIGS. 9 and 10. When the fourth hub member [400] and the third hub member [300] are pushed together, the tapering length [102]-[110], which surrounds second tube [200] and is concentric with it, is pushed towards third hub member [300] until the end [102] of the tapering length [102]-[110], enters the tapering region [315]. At a point in tapering region [315] of third member [300], the clearance becomes inadequate for further relative insertion of tapering length [102]-[110]. The upper end [120] of tapering length [102]-[110] then is forced between the second tube [200] and the inner wall of the luer like passage [315]. The members [300] and [400] are then locked together, along with the two tubes [100] and [200].

When release of the locking is desired, for example so that the moveable second inner tube [200] can be repositioned with respect to the fixed tube [100], the locking force can be removed by holding third hub member [300] in one hand and displacing fourth hub member [400] in a direction away from third hub member [300], using the thumb of the same hand, or the other hand. The pressure required to unlock is less than about ten pounds-force (4.5 kg-force).

### Alternative Combinations and Enhancements of Components

One skilled in the art can appreciate that other combinations of materials and geometric constructs for the functional embodiments may be employed in alternate arrangements to achieve a locking condition of the assembly. What is critical for function in the most preferred, lowest cost manufacturing configuration is that there be at least one or more compliant components, as defined by their composition modulus [‘E’], such that at least one of the first, second or third members is 10% or less of the modulus [‘E’] of one of the other two members.

The modulus of the fourth member is not critical to the locking feature of the assembly. However, the modulus of the fourth member is most preferably also 1/10^{th} or less of the modulus [‘E’] of one of the other three members, to enable a snap fit function with the third member. As such any combination having one of first, second and third members meeting this criterion of lower modulus is considered to be within the scope of this invention. Having the third and fourth members ([300], [400]) as the components with the lower moduli is preferred.

Third sliding outer hub member [300] and fourth hub member [400] may also have additional ergonomic external features integrated into their design to assist or enhance a one handed operation, such as finger loops, flanges, curved finger geometry or other such ergonomic handle geometry constructs as are typically seen in device actuators intended for single hand use. Such actuators may be, but are not limited to, one hand looped syringe injectors and single hand handle designs used in the art. All such enhancements or configurations, while not specifically illustrated, are considered to be within the scope of this invention.

A further alternate enhancement is the insertion of fluid seals, such as lip seals or o-rings, into third hub member [300] at the distal zone features of [312] and/or proximal zone features [313] of third hub member [300], such that said sealing embodiments are sufficiently positioned and tensioned within the assembly to engage member [200] (in zone [312]) and member [100] (in zone [313] to effect a leak tight seal of the assembly while allowing for the rotation and axial translation of said tubular members as has been described in the preferred embodiment. Alternatively these sealing embodiments may be part of fourth hub member as well. Such an embodiment is useful in the delivery of fluids through a catheter or in the controlling of instruments or inflatable devices positioned along and/or at the distal end of a catheter like assembly.

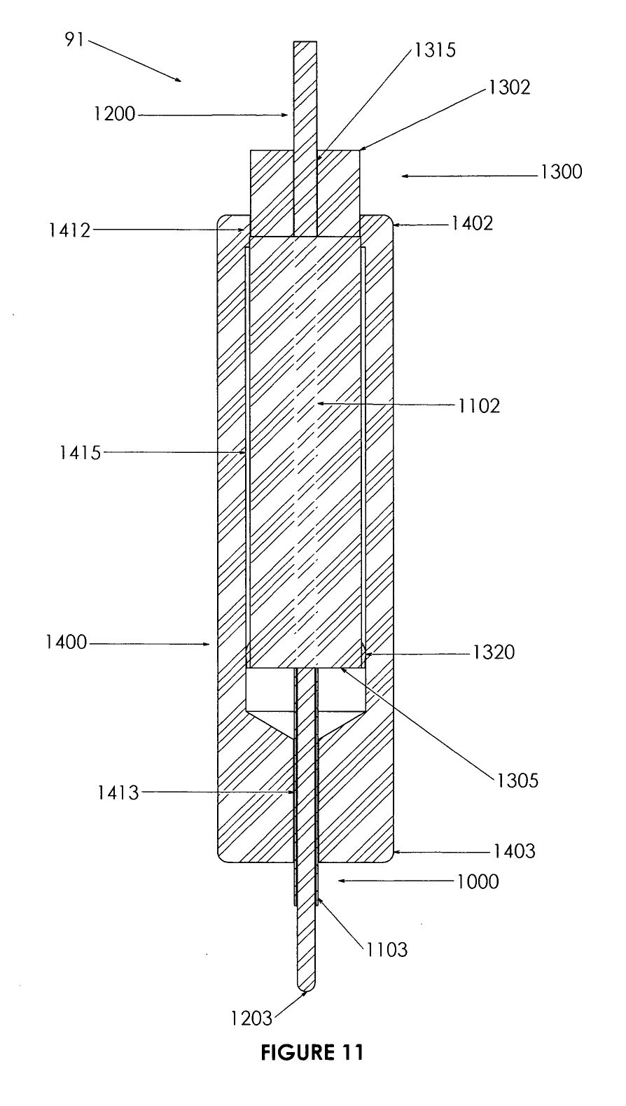

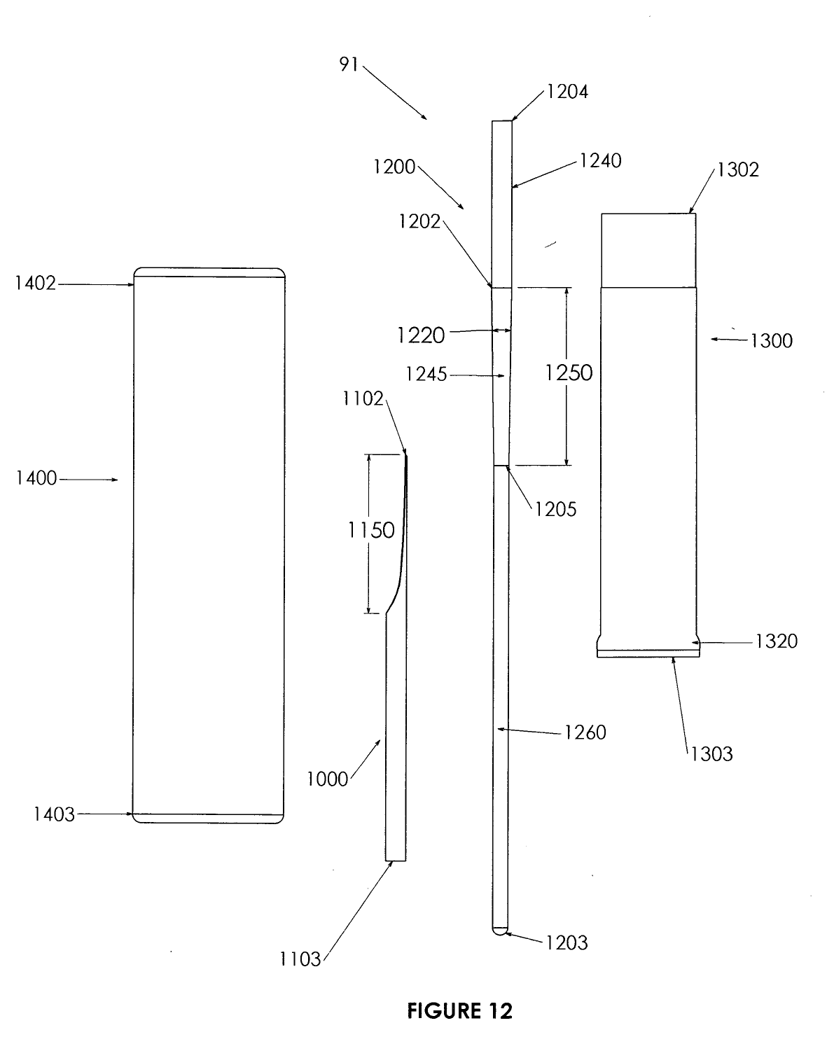

In addition, the functional elements of the invention can be combined in different ways to produce the same effect. FIG. 11 shows a cross-section view and FIG. 12 an exploded view of a Tubular Slide Lock Mechanism [91] showing a different arrangement of features functioning within the scope of the invention.

As in FIGS. 9 and 10 above (embodiment [90]), in embodiment [91] there are four main pieces. First outer tubing [1000] with a profile [1150] and a narrow tip at distal end [1102] is similar in profile taper and function to outer tube [100] and profile [150] in FIG. 6. Second inner tube [1200] in this embodiment has a distal diameter [1240], similar to first outer tube [1100], from its most distal end [1204] to an intermediate more proximal location [1202], followed by a tapering zone [1245], defined by taper angle [1220] beginning at distal location [1202] and ending at more proximal location [1205], so that the length of taper [1250] is about equal to the length of feature [1150] of first outer tube [1000]. Second inner tube [1200] is further connected at location [1205] to a more proximal diameter [1260] and can slideably and rotationally reside within the inner diameter of first outer tube [1000] (best seen in FIG. 11) and proximally terminates at a location [1203] which in the preferred embodiment extends well beyond proximal end [1103] of first outer tube [1000].

In embodiment 91, third hub member [1300] (best seen in FIG. 11), has an inner passage [1315] running from distal end [1302] to proximal end [1305] through which first tube [1000] and the distal portion [1240] of second tube [1200] can pass freely. Third hub member [1300] further has a snap feature [1320] at its proximal end.

Outer fourth member [1400] has an outer distal end [1402] and a proximal end [1403] and a passage within defined by a snap feature [1412] at distal end [1402] to engage the snap [1320] of third hub member [1300], an inner chamber [1415] for third hub member [1300] to reside and a proximal passage [1413] through which both outer tubing [1000] and inner tubing proximal end [1260] residing within first outer tube [1000] can pass freely. Outer tubing [1000] is optionally and preferably immobilized or fixed to outer member [1400] along feature [1413] so that there is no relative movement.

In this embodiment hub member [1300] is freely able to axially slide with limits controlled by the engaging of snap features [1320] and [1412] respectively Such movement is intentionally limited such that projection [1150] of member [1000] is always residing within the inner bore of hub member [1300] regardless of position.

Locking is attained by a proximal movement of member [1200] in relation to member [1400] which is attached to member [1000] along location [1413] while holding the position of member [1300]. The proximal motion of [1200] relative to [1000] pulls the tapering zone [220] more deeply into the projection [150] which then in concert with [1245] engages hub member [1300] thus locking the assembly from movement. A distal movement of member [1200] will then disengage the assembly, allowing hub member [1300] to then freely slide and rotate as before.

Embodiments of this invention have been described as “tubular” or “cylindrical”, and in the illustrations have been presented as rod-like or tube-like constructs. However, the locking geometry of the invention is also applicable to non-rotating types of geometry cross sections, such as squares, rectangles, triangles, splines or polygons. If such geometries are manufactured in a tubular form, the locking principles of the invention can be applied in design and function. Accordingly, such geometries and relationships are considered to be within the scope of the invention.

### Manufacturing Methods

Low cost and high volume manufacturing methods can be utilized on all the embodiments of the present invention. For example first outer tubular member [100] and all the geometry of its preferred embodiment as a stainless steel composition can be manufactured utilizing Wire EDM, Laser, Water Jet, Photo Etching or Grinding and Cutting technology to achieve critical functional features and relations as illustrated in FIGS. 3, 4, 5 and 6 (features [102], [110], [120], [130] & [150] respectively).

Second inner member [200] is a simple wire or tube in any material composition selected, and for the version shown in FIGS. 11 and 12, the proximal end of the wire or tube can be reduced in diameter for short stretches by swaging or similar techniques.

One or both of third sliding outer hub member [300] and fourth hub member [400] are preferably comprised of engineering thermoplastics, which can be injection molded with high precision and low cost, or simply machined using high speed lathes. Similar options apply to the embodiment of FIGS. 11 and 12.

Devices of the claimed design are useful in medicine, surgery, and related disciplines, in diagnosis, observation and treatment of humans and other living beings. It may be useful and desirable for patient safety to manufacture specific embodiments in biodegradable materials or materials that will indicate, fluoresce, or cease function completely, if re-sterilized for a second patient procedure. Such methods of disabling devices ensures that diseases and infection can be contained and constrained from inadvertent propagation in the population and is a desired control strategy for disease and infection control. Manufacturing methods illustrated and discussed are easily ably to cost effectively produce components with these additional attributes.

Various embodiments and figures have been described in this specification to allow it to be understood by persons of ordinary skill in the appropriate arts. The scope of the invention is not limited to the specific embodiments described, but is limited only by the scope of the claims.

1. A reversibly lockable system of cylindrical components, wherein said system comprises a first outer tube, a second inner component and a third sliding outer hub member,
wherein said first outer tube has a distal segment which is partially cut away to create a partially elliptical cutaway projection profile; and
wherein one of said third outer sliding hub member and said second inner component has a tapered segment, at the end of said component or member which is closest to said first outer tube, that is too small for passage therethrough of said first outer tube.

2. The reversibly lockable system of claim 1 wherein said reversibly lockable system further comprises a fourth hub member which reversibly locks with said third sliding member, and wherein said first outer tube is secured to said fourth hub member.

3. The reversibly lockable system of claim 2 wherein said third hub member and said fourth hub member can be reversibly forced together to lock the components of said system.

4. The reversibly lockable system of claim 2 wherein said system is locked by forcing together said component having a tapered segment and said cut away segment of said outer tube.

5. The reversibly lockable system of claim 2 in which said projection of said distal segment of said outer tube is cut away so that at its distal end it has less than one-fourth of the circumference that it has at the proximal end of said outer tube.

6. The reversibly lockable system of claim 2 in which the projection of the distal segment of said outer tube is cut away so that said projection at its distal terminus has a taper with a projection angle of less than about 10 degrees to its proximal terminus.

7. The reversibly lockable system of claim 2 wherein said reversibly lockable system can be operated with one hand.

8. The reversibly lockable system of claim 7 wherein the distal length of said first outer tubing beyond its bonding point is sufficient to allow said projection to project into a region where it can interact with a tapered region.

9. The reversibly lockable system of claim 2 in which at least one of the first, second, third and fourth members has a Young's modulus E that is one-tenth or less of the value of a Young's modulus of at least one other member.

10. The reversibly lockable system of claim 2 in which least two of the first, second, third and fourth members have a Young's modulus E that is one-tenth or less of the value of a Young's modulus of at least one other member.

11. The reversibly lockable system of claim 2 in which least two of the first, second, third and fourth members are made of biodegradable materials that will disintegrate or dissolve on re-sterilization.

12. The reversibly lockable system of claim 1 in which at least one of the first, second and third members has characteristic properties selected from having a Young's modulus E that is about one-tenth or less of the value of a Young's modulus of at least one other member; and in being made of biodegradable materials that will disintegrate or dissolve on re-sterilization.

13. A method for reversibly locking together cylindrical components, wherein the components comprise a first outer tube, a second inner cylindrical component and a third sliding outer member, and wherein said first outer tube has a tapered concentric projection at one end thereof, and a generally elliptical cutaway projected profile, the method comprising the steps of:
a) passing said second cylindrical component through a first passage in a third sliding outer member;
b) passing said tapered concentric projection of said first outer tube over said second inner cylindrical component and into said passage; and
c) applying force to said first outer tube and to said third sliding outer member to force said projection further along said second inner cylindrical component until said inner and outer tube and third sliding member lock together.

14. The method of claim 13 wherein said system further comprises a fourth hub member which reversibly locks with said third sliding member.

15. The method of claim 14 wherein said third member and said fourth member can be forced together to reversibly lock the components of said system.

16. The method of claim 14 wherein said tapered segment is characterized in having a half-angle of taper of less than about 3 degrees.

17. The method of claim 14 wherein said locking is reversed by applying pressure to separate said hubs.

18. A system for locking together concentric cylindrical components,
wherein the system comprises a first hub, a first outer tube and a second inner cylindrical component,
and wherein said outer hub comprises an outer diameter, a length, a wall thickness and a cylindrical inner diameter therein through a defining a passageway;
wherein said first outer tube comprises an outer diameter allowing said first tube to pass through said first hub passageway unimpeded, said first outer tube comprising:
an inner passageway of said first tube defined by said inner diameter
and a projection at said first tube distal end characterized in that said projection is a cylindrical extension of said outer tube that has less than one-fourth of the circumference of said tube at the most distal end;
wherein said second inner cylindrical component comprises a cylindrical proximal end, a cylindrical distal end, and a tapered section there between;
and said proximal end diameter of said second inner cylindrical component is diametrically sized to pass within said passageway of said first outer tube, such that said second inner cylindrical, component proximal end resides within said first outer tube,
and wherein said outer first tube is able to slide and rotate freely on said proximal end of said second cylindrical member;
and wherein said distal end diameter of said second cylindrical component defines an outer diameter that allows unimpeded passage of said distal end through said first hub passageway, said diameter being substantially equivalent to said outer diameter of said first outer tube;
wherein by positioning said first outer tube projection of said first tube within said first hub passageway, and slideably actuating said second inner cylindrical component, said sliding action will engage second inner cylindrical component taper section, which is residing within said first outer hub passageway with said first outer tube projection and said first hub passageway, thereby reversibly locking together said first outer tube, said second inner cylindrical component and said first hub,

19. The system of claim 18 wherein said system further comprises a fourth hub member which reversibly locks with said third hub member.

20. The method of claim 19 wherein said fourth member and said second inner cylindrical component can be reversibly forced together to lock the components of said system.

21. The system of claim 20 wherein said first outer tube is affixed to said fourth hub member, to which force may be applied.
